(19) United States
(12) Patent Application Publication
(10) Pub. No.: US 2014/0006471 A1
(43) Pub. Date: Jan. 2, 2014

(54) DYNAMIC ASYNCHRONOUS MODULAR FEED-FORWARD ARCHITECTURE, SYSTEM, AND METHOD

(71) Applicant: Horia Margarit, San Diego, CA (US)

(72) Inventor: Horia Margarit, San Diego, CA (US)

(21) Appl. No.: 13/535,342

(22) Filed: Jun. 27, 2012

(51) Int. Cl. G06F 15/16

(52) U.S. Cl. 709/201

(57) ABSTRACT

Embodiments of architecture, systems, and methods for minimizing costs and errors in a feed-forward network receiving sparse or correlated data are described herein. Other embodiments may be described and claimed.

### CROSS REFERENCE TO RELATED APPLICATIONS

The present Application for Patent claims priority to Patent Application No. 61/501,246 entitled “DYNAMIC ASYNCHRONOUS MODULAR FEED-FORWARD ARCHITECTURE, SYSTEM, AND METHOD,” filed Jun. 27, 2011, and hereby expressly incorporated by reference herein.

### TECHNICAL FIELD

Various embodiments described herein relate to apparatus and methods for modular feed-forward networks.

### BACKGROUND INFORMATION

It may be desirable to minimize costs and errors in a feed-forward network receiving sparse or correlated data. The present invention provides architecture, systems, and methods for same.

### BRIEF DESCRIPTION OF THE DRAWINGS

FIG. 1A is a diagram of a data processing module network according to various embodiments.

FIG. 1B is a diagram of a data processing module network according to various embodiments.

FIG. 1C is a diagram of a data processing module network according to various embodiments.

FIG. 1D is a simplified block diagram of a data processing module network according to various embodiments.

FIG. 2 is a diagram of an architecture including several modules of a network according to various embodiments.

FIG. 3 is a block diagram of a hardware module that may be employed by a data processing module according to various embodiments.

FIG. 4 is diagram of a data vector according to various embodiments.

FIG. 5A is a simplified block diagram of a data processing module architecture according to various embodiments.

FIG. 5B is a diagram of vectors and weighting matrix configurations according to various embodiments.

FIG. 5C is a diagram of an input data matrix and a pruning matrix configuration according to various embodiments.

FIG. 6A is a flow diagram illustrating several methods according to various embodiments.

FIG. 6B is a flow diagram illustrating several other methods according to various embodiments.

FIG. 7 is a diagram of an activation correlation matrix configuration according to various embodiments.

FIG. 8A is a diagram of a data processing module network showing matrix elements according to various embodiments.

FIGS. 8B-8D are diagrams of data processing module networks showing matrix elements and having one or more connections inactive according to various embodiments.

### DETAILED DESCRIPTION

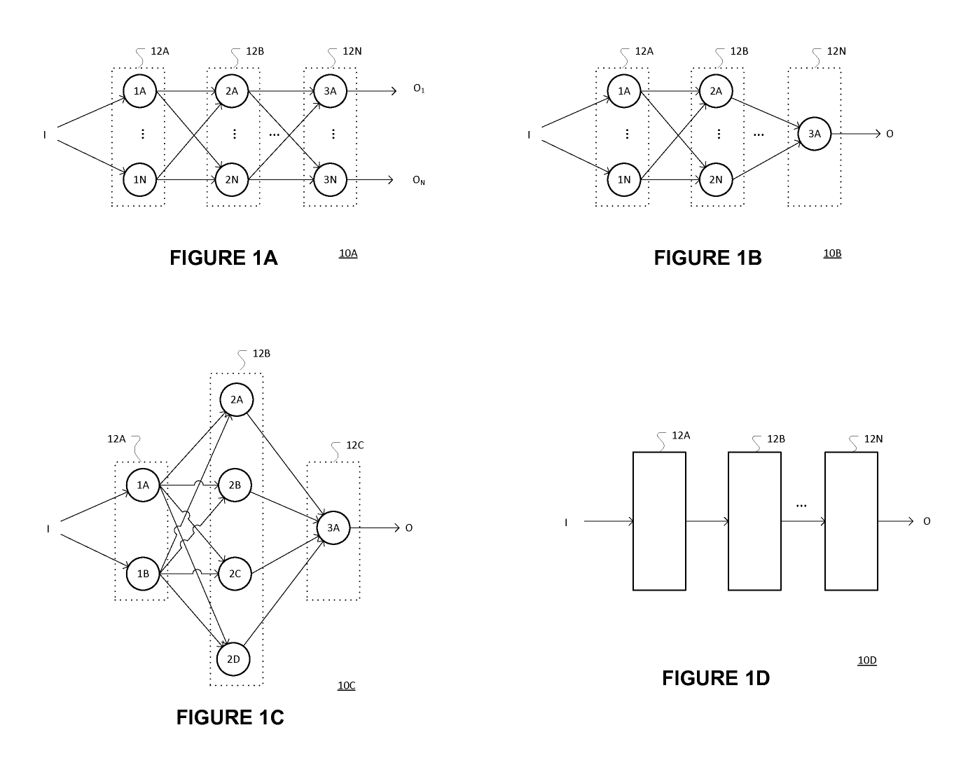

FIG. 1A is a diagram of a data processing module network or instance 10A according to various embodiments. The network 10A includes a plurality of layers 12A, 12B to 12N and each layer 12A, 12B to 12N includes one or more data processing or computational unit modules 1A to 1N, 2A to 2N, and 3A to 3N, respectively. Each DPM 1A to 1N, 2A to 2N, and 3A to 3N receives data or a data vector and generates output data or data vector. Input data or a data vector I may be provided to the first layer 12A of data processing modules (DPM) 1A to 1N. In an embodiment each DPM 1A to 1N, 2A to 2N, and 3A to 3N of a layer 12A, 12B, 12C may be fully connected to adjacent layer(s) 12A, 12B, 12N DPM 1A to 1N, 2A to 2N, and 3A to 3N. For example DPM 1A of layer 12A may be connected to each DPM 2A to 2N of layer 12B.

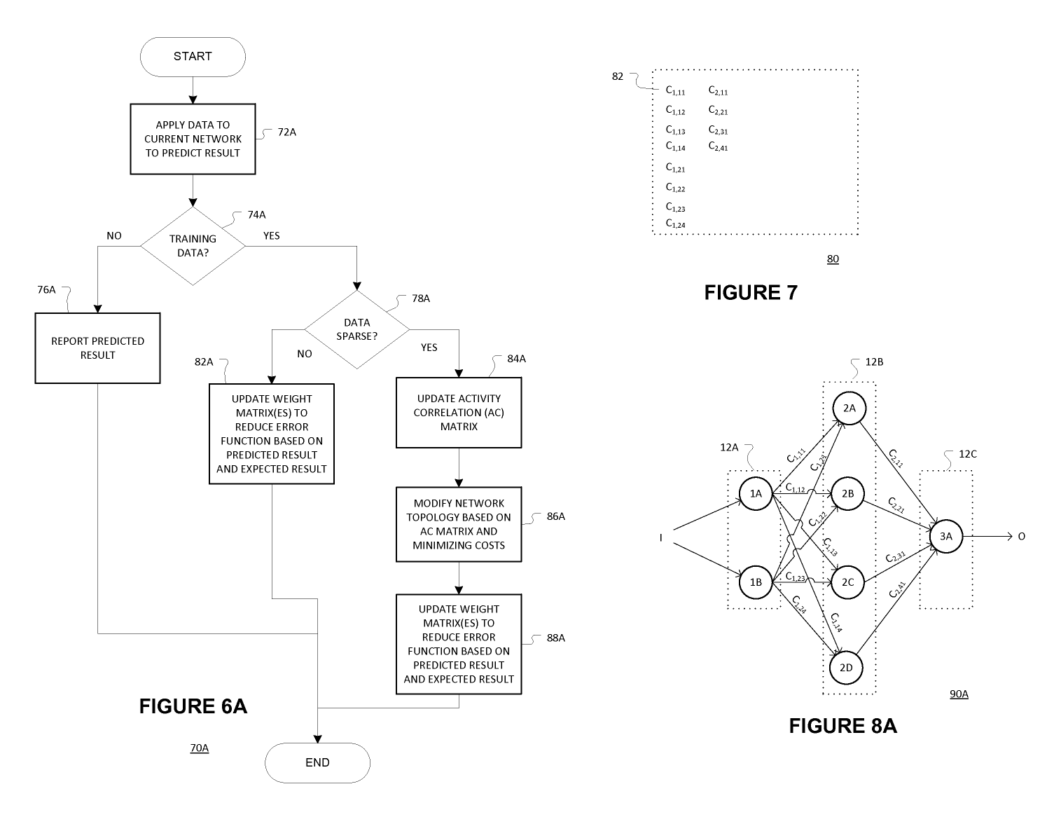

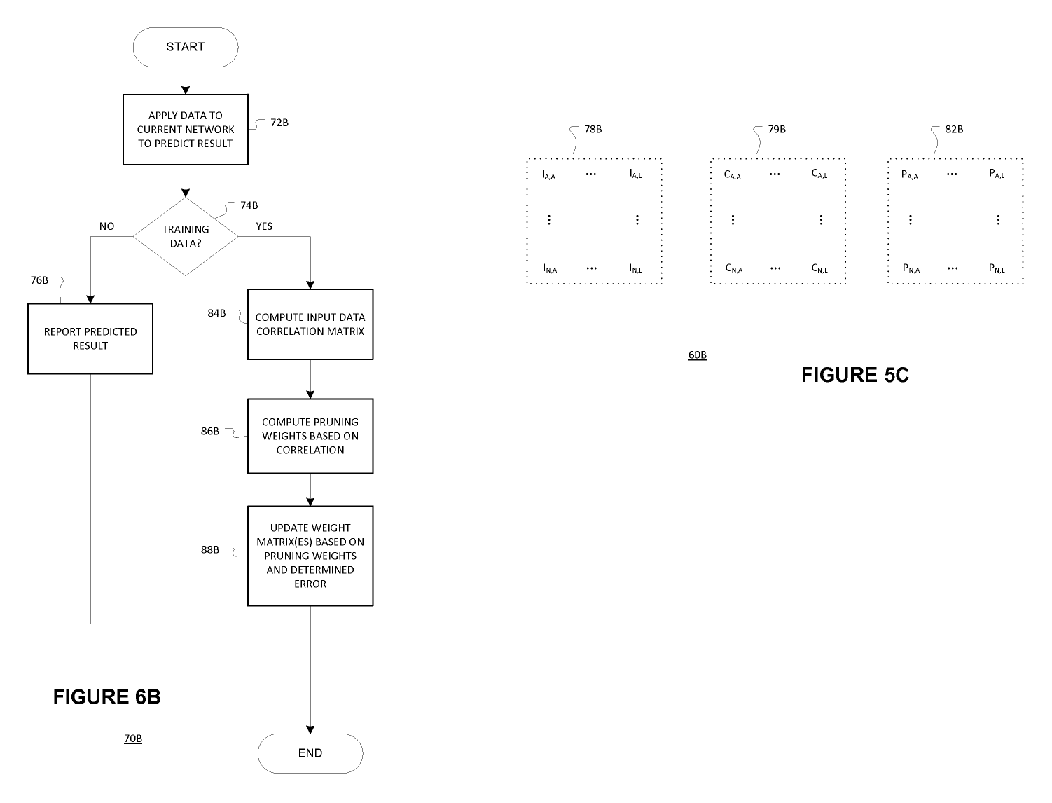

In an embodiment the network 10A may represent a neural network and each DPM 1A to 1N, 2A to 2N, and 3A to 3N may represent a neuron. Further, each DPM 1A to 1N, 2A to 2N, and 3A to 3N may receive multiple data elements in a vector and combine same using a weighting algorithm to generate a single datum. The single datum may then be constrained or squashed with a constraint of 1.0 (or squashed to a maximum magnitude of 1.0) in an embodiment. The network may receive one or more data vectors that represent a collection of features where the features may represent an instant in time (see input matrix 78B of FIG. 5C where each column I_{Ax} represents a vector with length N instance in time x and the number of columns L is the number of instances). The feature or data matrix 78B may represent a digital, visual reproduction of an element in an embodiment and the network 10A may be configured to determine if the visual reproduction is equal or correlated to a particular element such as a written character, person, or other physical element.

In an embodiment the network 10A may receive input training vectors (matrix 78B) with a label or expected result or prediction. The network 10A may employ or modulate weighting matrixes (see FIGS. 5A to 5B) to reduce a difference between the expected result or label and a result or label predicted by the network, instance, or model 10A, 50. An error or distance E may be determined by a user defined distance function in an embodiment. The network or model 10A, 50 may further include functions that constrain each layer's DPM 1A to 1N, 2A to 2N, 3A to 3N magnitude to attempt to train the model or network 10A, 50 to correctly predict a result or label when corresponding feature vectors (FIG. 4, 40) are presented to the network or model 10A, 50 as input(s) I.

In the network 10A each DPM 3A to 3N of the final layer 12N may provide an output data, predicted result, or data vector O₁ to O_{N}. FIG. 1B is a diagram of a data processing module network 10B according to various embodiments. The network 10B is similar to network 10A shown in FIG. 1A. In the network 10B the final layer 12N provides a single output datum, predicted result, or data vector O via the DPM 3A. FIG. 1C is a diagram of a data processing module network 10C according to various embodiments. The network 10C shown in FIG. 1C includes three layers 12A, 12B, 12C. The first layer 12A includes two (2) DPM or neurons 1A, 1B. The second layer 12B includes four (4) DPM 2A, 2B, 2C, 2D or neurons. The third layer 12C includes a single (1) DPM or neuron 3A. In the embodiment 10C each layer 12A, 12B, 12C is fully connected to their adjacent layers 12A, 12B, 12C, i.e., each downstream DPM 1A to 1B, 2A to 2D is connected to each upstream DPM 2A to 2D, 3A, respectively. The network 10C may be referenced as a {2,4,1} network, representing the number of DPM 1A, 1B, 2A, 2B, 2C, 2D, 3A in each layer.

FIG. 1D is a simplified block diagram of a data processing module network 10D according to various embodiments. In the network 10D the layers 12A, 12B to 12N are fully connected and a single connecting line is shown to represent this condition. Each layer 12A, 12B to 12N may include one or more DPM 1A to 1N, 2A to 2N, and 3A to 3N as shown in FIG. 1A. FIG. 1D is a simplified representation of FIG. 1A in an embodiment. The networks 10A, 10B, 10C, 10D may termed feed-forward networks given the output of each downstream DPM 1A to 1B, 2A to 2D is only forwarded to upstream DPM 2A to 2D, 3A, respectively—no feedback from upstream DPMs 2A to 2D, 3A to downstream DPM 1A to 1B, 2A to 2D, respectively.

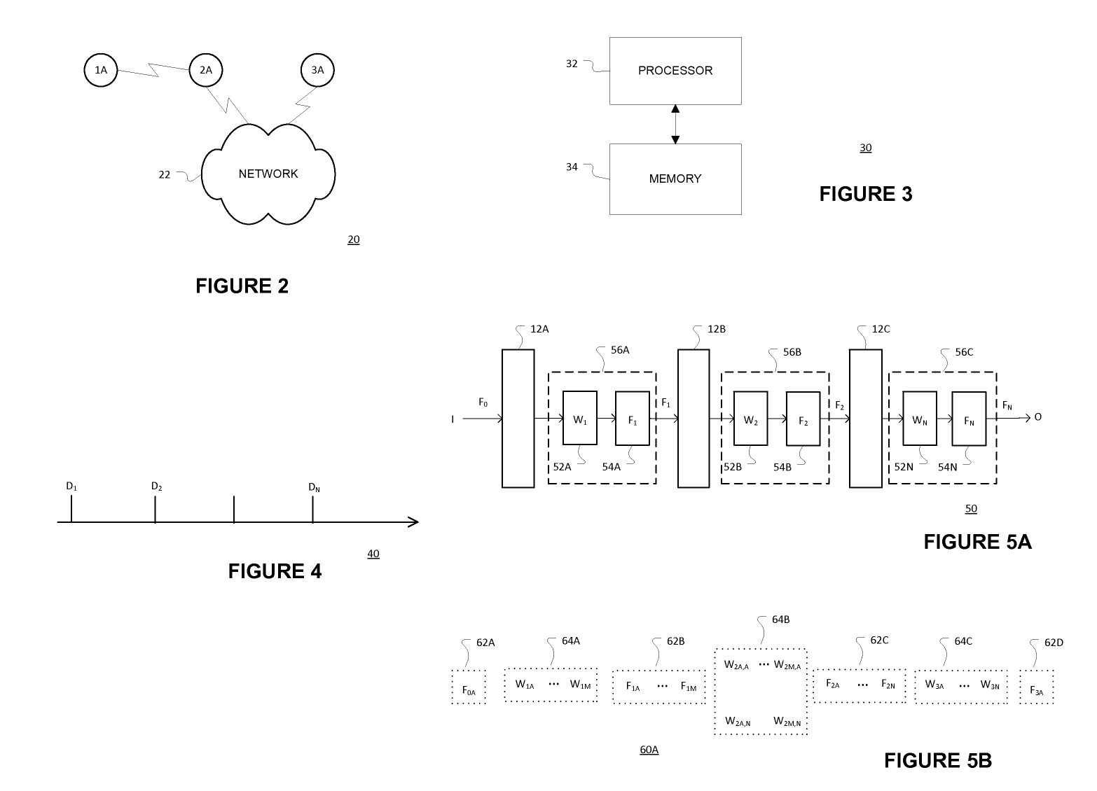

During training or other various embodiments data vectors representing various features or elements may include blank or empty datum such as shown in FIG. 4, 40. In an embodiment a user defined cost function may be associated with each connection between DPM 1A to 1N, 2A to 2N, and 3A to 3N and each active DPM 1A to 1N, 2A to 2N, and 3A to 3N. As shown in FIG. 2 and FIG. 3, each DPM 1A to 1N, 2A to 2N, and 3A to 3N may include a processor 32 and memory 34 and use a network connection to communicate data vectors upstream between DPM 1A to 1N, 2A to 2N, and 3A to 3N. Connections between DPMs 1A to 1N, 2A to 2N, and 3A to 3N may consume network and processing resources.

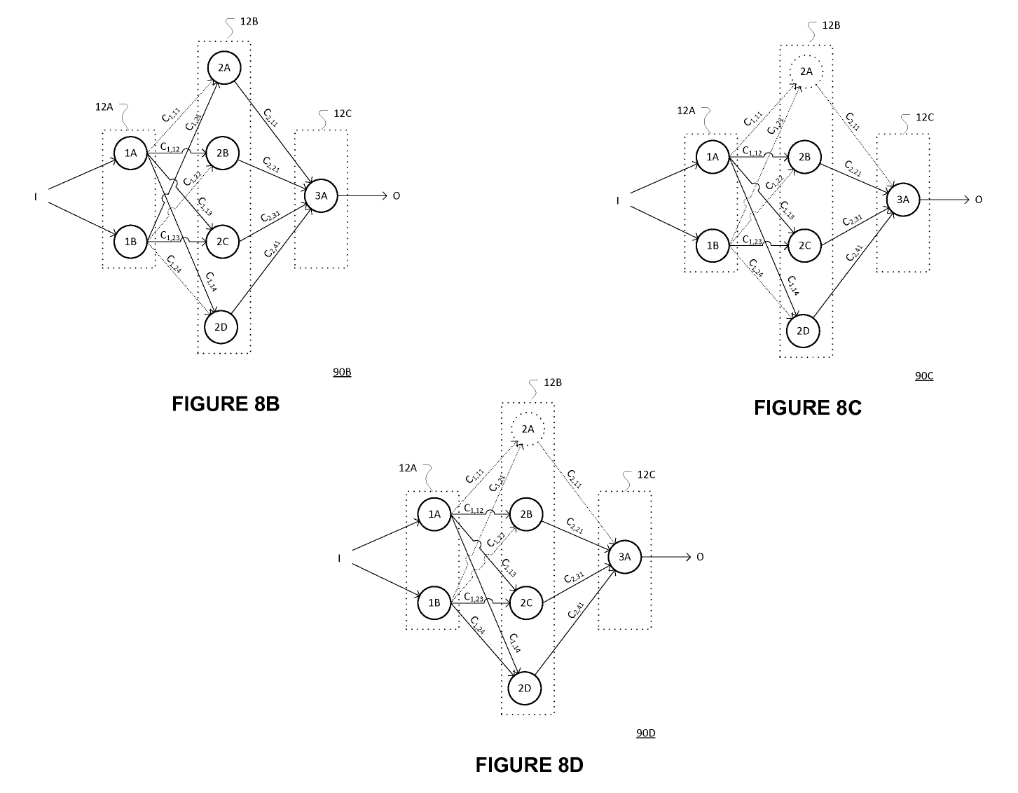

When a DPM 1A to 1N, 2A to 2N, and 3A to 3N is not generating valuable data or a connection between DPMs 1A to 1N, 2A to 2N, and 3A to 3N is not sufficiently active the present invention may not create or maintain a connection by modifying the weights applied between DPMs connections (see FIGS. 8B to 8D) or a DPM 1A to 1N, 2A to 2N, and 3A to 3N (see FIG. 8B to 8D) to reduce the cost function C. In an embodiment a correlation matrix (79B of FIG. 5C) representing the correlation of several instances of input data I may be determined (activity 84B of process 70B) and a pruning matrix (82B of FIG. 5C) including effective pruning or DPM connection weights may be determined or computed (activity 86B) based on the input data correlation matrix 79B. The determined pruning or DPM connection weights of the pruning matrix 79B may also reduce the cost function C.

In an embodiment the present invention may asynchronously reduce the function E and the cost function C when sparse training data vectors or correlated training data vectors are processed. The present invention may reduce the function E by modifying weighting matrixes W (FIGS. 5A, 5B) to reduce the distance between a calculated or predicted result or label and the expected result or label (based on labeled training vectors). The present invention may reduce the cost function C by monitoring the activity between DPMs 1A to 1N, 2A to 2N, and 3A to 3N via an activity correlation matrix (see FIG. 7) and inactive connection between one or more DPMs 1A to 1N, 2A to 2N, and 3A to 3N or effectively a DPM 1A to 1N, 2A to 2N, and 3A to 3N (when all incoming or outgoing connections are inactive for a particular DPM 1A to 1N, 2A to 2N, and 3A to 3N), see FIGS. 8A to 8D. Such actions may occur where the data generated by a layer DPMs 1A to 1N, 2A to 2N, and 3A to 3N is highly correlated. In an embodiment the connections may be effectively reduced via the pruning matrix 82B based on the computed input data vector correlation matrix 79B.

FIG. 2 is a diagram of architecture 20 including DPM 1A, 2A, 3A of a network 10A, 10B, 10C, 10D according to various embodiments. In an embodiment one or more DPM 1A to 1N, 2A to 2N, 3A to 3N may be sub-modules of a single module or processor (32 shown in FIG. 3). In other embodiments 20 a DPM 1A may be part of a processor 32 different from the DPM 2A and DPM 3A. Further data or data vector(s) communicated between DPM 1A, 2A, and 3A may be communicated via single device, on local network (such as between 1A and 2A) and on an external network 22 (such as between 2A and 3A). Accordingly DPM 1A to 1N, 2A to 2N, 3A to 3N of a network or instance 10A, 10B, 10C, 10D may distributed between many network and devices. The network 22 may be network of network (termed the Internet), a private network, a wireless network, a cellular network, and a satellite based network (at least one segment communicated on an external network).

FIG. 3 is a block diagram of a hardware module 30 that may be include one or more data processing modules 1A to 1N, 2A to 2N, 3A to 3N according to various embodiments. The module 30 may include a processor module 32 coupled to a memory module 34. In an embodiment the memory module 34 and processor module 32 may exist on a single chip. The processor module 32 may process instructions stored by the processor 32 or memory module 34 to perform the functions of one or more DPM 1A to 1N, 2A to 2N, 3A to 3N. The processor module 32 may further process instructions stored by the processor 32 or memory module 34 to communication data or data vectors on a network 20. The processor 32 may also apply weighting matrix elements to DPM 1A to 1N, 2A to 2N, and 3A to 3N outputs. The processor 32 may further apply a user defined function F₁, F₂, F₃ to weighted, DPM 1A to 1N, 2A to 2N, and 3A to 3N outputs.

FIG. 5A is a simplified block diagram of a data processing module network 50 according to various embodiments. The network 50 includes layers 12A, 12B, 12C and post-output processing modules 56A, 56B, 56C. FIG. 5B is a diagram of input vectors 62A, 62B, 62C, 62D and weighting matrixes 64A, 64B, 64C configurations according to various embodiments. The data vectors F0 62A, F₁ 62B, F₂ 62C, and F₃ 62D represent the input vector for each layer 12A, 12B, 12C, and the result or label O. In embodiment the output of each layer 12A and each DPM 1A to 1N, 2A to 2N, and 3A to 3N accordingly is processed by a post-output module 56A, 56B, 56C. Each post-output module 56A, 56B, 56C includes a weighting module 52A, 52B, 52C and a function F₁, F₂, F₃ module 54A, 54B, 54C.

In an embodiment each weighting module 52A, 52B, 52C applies weights determined or generated by the error function E to each DPM 1A to 1N, 2A to 2N, and 3A to 3N output. The network 50 may have a configuration {2,4,1} in an embodiment and the weighting matrixes 64A, 64B, 64C are a 1×2, 2×4, and 4×1, respectively. Then a user defined function F₁, F₂, F₃ may be applied to the weighted DPM output as shown in FIG. 5A via a function F₁, F₂, F₃ module 54A, 54B, 54C.

FIG. 6A is a flow diagram 70A illustrating several methods according to various embodiments. In an embodiment one or more data vectors 40 may be applied to a network 10A-D, 50, 90A-C to predict a result or label (activity 72). When the one or more data vectors 40 include the expected result or label, i.e., are training data (activity 74A) the present invention asynchronously optimize the function E (activities 82A and 88A) and the cost function C (activities 84A and 86A). Otherwise when the data vectors input to the network do not include an expected result or label the method 70A may report the network output O—predicted result or label (activity 76A).

In method 70A when the training data vectors 40 are sparse (missing a predetermined number of datum) (activity 78A) the present invention may attempt to optimize or reduce costs C based on the user defined cost function where costs increase with the number of connections between DPMs in a network. In an embodiment the method 70A may update elements of an activation correlation (AC) matrix 80 of FIG. 7 (activity). Each AC matrix element may have an initial value of 1.0 and may be reduced to a floor of 0.0 and increased to a ceiling of 1.0 as a function of how often the DPM connection represented by the element are activated. In AC matrix 80 each element C includes subscripts X,YZ where X represents the downstream DPM layer number, Y represents the position of the DPM in the downstream layer, and Z represents the position of the connected DPM in the upstream layer. For example C_{1,23} is the element representing the connection between DPM 1B (layer 1, DPM number 2) and DPM 2C (upstream DPM, number 3). This correlation is also shown in FIGS. 8A to 8D.

When a AC matrix element C reaches a predetermined minimum, the corresponding connection between respective DPMs may be made inactive. In network 90B, connections between DPM 1A and 2A, DPM 1B and 2B, and DPM 1B and 2D have been made inactive as indicated by the dashed lines. This connection reduction may lower the cost C of operating this network 90B given less bandwidth and processing time. In network 90C, the connection between DPM 1B and 2A is also inactive. In this embodiment the DPM 2A is effectively inactive since it has no input connections. Accordingly its output to DPM 3A is also made inactive. In an embodiment the potential activity of inactive connections (between DPMs) may also be monitored so an AC matrix element may increase. When the corresponding AC matrix element is greater than a predetermined minimum threshold the connection between respective DPMs may be restored or made active such as the connection between DPM 1B and 2D in network 90D of FIG. 8D.

In an embodiment a weighting element (such as W_{2A,A} of matrix 64B) of a matrix 64A, 64B, 64C may be modulated by its previous value in addition to the error function E distance optimization. For example W_{2A,A} (t) may be equal to a combination of the new determined value (W_{2A,A}′) and a scaled portion of W_{2A,A} (t−1), i.e., W_{2A,A} (t)=a W_{2A,A}′+(1−a) W_{2A,A} (t−1) (where a is the scale and between 0.0 and 1.0). In an embodiment a user may choose a or it may be randomly generated.

Any of the components previously described can be implemented in a number of ways, including embodiments in software. Any of the components previously described can be implemented in a number of ways, including embodiments in software. Thus, the data processing units 1A to 1N, 2A to 2N, 3A to 3N, instance segments 12A, 12B, 12C to 12N, weighting matrixes 64A, 64B, 64C, instances 10A, 10B, 10C, 10D, 50, 90A-D, processor 32, memory 34 may all be characterized as “modules” herein. In an embodiment the method 70B may be employed to modify or further modify connections or weighting functions W between DPMs and thereby the input vectors for each DPM of a layer.

It is noted that system may consist of a single layer in an embodiment. It is further noted that the single layer system may include one or more DPMs. In the method 70B, when training data is received (activity 74B), a correlation matrix (79B of FIG. 79B) may be determined based on the several input vectors (78B of FIG. 5C) for each layer 12A, 12B, . . . 12N (where N may be 1 in an embodiment). The method may then determine or compute pruning weights (in the form of a matrix 82B of FIG. 5C) based on the determined input data correction matrix 79B (activity 86B) for each layer input vectors. The connection weights W may be modified or modulated based on the pruning weights or matrix 82B (activity 88B). The pruning weights may then effectively attenuate noise or redundant information in the input vectors provided to each layers. It is noted that each layer 12A, 12B to 12N may be considered a module of a system 10A, 10B, 10C, where each layer 12A, 12B, to 12N may linearize the system into independent, linear modules.

In an embodiment the pruning matrix 82B may reduce the effect of highly correlated inputs to one or more DPM 1A to 1N, 2A to 2N, 3A to 3N. The pruning weighting may be exponentially related to the correlation between two inputs. In an embodiment a pruning weight may be equal to 1/e_{|corr(x,y)|} where a pruning weight may be about 0.37 where the correlation of two inputs is about 1. In an embodiment the method 70B may employ a first order correction between all inputs and scale each input by a weighted linear combination of the corresponding pruning matrix row. It is noted that the pruning weight may be applied to an input data vector.

The modules may include hardware circuitry, single or multi-processor circuits, memory circuits, software program modules and objects, firmware, and combinations thereof, as desired by the architect of the architecture 10 and as appropriate for particular implementations of various embodiments. The apparatus and systems of various embodiments may be useful in applications other than a sales architecture configuration. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within and couplable to a variety of electronic systems, such as televisions, cellular telephones, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.) and others. Some embodiments may include a number of methods.

It may be possible to execute the activities described herein in an order other than the order described. Various activities described with respect to the methods identified herein can be executed in repetitive, serial, or parallel fashion. A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus, the following claims are hereby incorporated into the Detailed Description, with each claim standing on its own as a separate embodiment.

What is claimed is:

1. A dynamic feed-forward system, comprising:
at least one data processing layer, each data processing layer including at least one data processing module, each data processing module generating an output vector from a sum of a weighted input data vector, each data processing layer receiving an input data vector and generating at least one output vector; and
a data processing module input weighting module for determining the weights to be applied to each input vector of each data processing module of the at least one data processing layer, the input weighting module modifying applied weights when the input vector received by the at least one data processing layer is sparse.

2. The dynamic feed-forward system of claim 1, the weighting module monitoring the activity between data processing modules and modifying connections between the modules based on the monitored activity.

3. The dynamic feed-forward system of claim 2, the weighting module updating an activity correlation matrix based on the monitored activity between data processing modules and modifying connections between modules based on the activity correlation matrix.

4. The dynamic feed-forward system of claim 3, wherein the dynamic feed-forward system includes a plurality of data process layers, one of the plurality of data processing layers receiving an input data vector, each of the other of the plurality of data processing layers receiving an input data vector from a downstream data process layer, and at least one data processing module of a downstream data processing layer providing data to an upstream data processing layer data processing module.

5. The dynamic feed-forward system of claim 3, the weighting module modifying the weights applied to each input vector to reduce the error between a calculated result and a predetermined result.

6. The dynamic feed-forward system of claim 3, the weighting module determining weights and modifying connections when the received input data vector represents training data.

7. The dynamic feed-forward system of claim 3, the weighting module computing the correlation between received input data vectors for each data processing layer and determining weights to be applied to input data vectors based on the correlation between input data vectors.

8. The dynamic feed-forward system of claim 7, the weighting module generating an input data correlation matrix based on received input data vectors for each data processing layer.

9. The dynamic feed-forward system of claim 8, the weighting module generating a pruning weight vector based on the input data correlation matrix.

10. The dynamic feed-forward system of claim 9, the weighting module modifying the weights applied to each input vector based on the error between a calculated result and a predetermined result and the pruning weight vector.

11. The dynamic feed-forward system of claim 9, the weighting module modifying weights to be applied to input data vectors based on a weighted linear combination of the corresponding pruning matrix row and the error between a calculated result and a predetermined result.

12. A dynamic feed-forward system, comprising:
at least one data processing layer, each data processing layer including at least one data processing module, each data processing module generating an output vector from a sum of a weighted input data vector, each data processing layer receiving an input data vector and generating at least one output vector; and
a data processing module input weighting module for determining the weights to be applied to each input vector of each data processing module of the at least one data processing layer based on the correlation between input data vector received at each data processing layer.

13. The dynamic feed-forward system of claim 12, the weighting module generating an input data correlation matrix based on received input data vectors for each data processing layer.

14. The dynamic feed-forward system of claim 13, the weighting module generating a pruning weight vector based on the input data correlation matrix.

15. The dynamic feed-forward system of claim 14, the weighting module modifying the weights applied to each input vector based on the error between a calculated result and a predetermined result and the pruning weight vector.

16. The dynamic feed-forward system of claim 14, the weighting module modifying weights to be applied to input data vectors based on a weighted linear combination of the corresponding pruning matrix row and the error between a calculated result and a predetermined result.

17. The dynamic feed-forward system of claim 12, the weighting module monitoring the activity between data processing modules and modifying connections between the modules based on the monitored activity.

18. The dynamic feed-forward system of claim 17, the weighting module updating an activity correlation matrix based on the monitored activity between data processing modules and modifying connections between modules based on the activity correlation matrix.

19. The dynamic feed-forward system of claim 12, wherein the dynamic feed-forward system includes a plurality of data process layers, one of the plurality of data processing layers receiving an input data vector, each of the other of the plurality of data processing layers receiving an input data vector from a downstream data process layer, and at least one data processing module of a downstream data processing layer providing data to an upstream data processing layer data processing module.

20. The dynamic feed-forward system of claim 19, the weighting module determining weights when the received input data vector represents training data.
